(19) United States
(12) Patent Application Publication
(10) Pub. No.: US 2007/0095898 A1
(43) Pub. Date: May 3, 2007

(54) Sheet processing apparatus and partition card user therefor

(75) Inventors: Teruhiko Uno, Mitaka-shi (JP); Toru Shijyo, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/584,534

(22) Filed: Oct. 23, 2006

(30) Foreign Application Priority Data
Oct. 24, 2005 (JP) 2005-308613

(51) Int. Cl. G07F 19/00

(52) U.S. Cl. 235/379

(57) ABSTRACT

A partition card having a radio chip is used, and identification information from the radio chip is detected by a card recognition unit.

### CROSS-REFERENCE TO RELATED APPLICATIONS

This application is based upon and claims the benefit of priority from prior Japanese Patent Application No. 2005-308613, filed Oct. 24, 2005, the entire contents of which are incorporated herein by reference.

### BACKGROUND OF THE INVENTION

1. Field of the Invention

The present invention relates to a sheet processing apparatus for discrimination processing of, for example, bills and the like, and a partition card on which information for classifying sheets to be handled, the type of card, and the like are recorded.

2. Description of the Related Art

It is often the case that when a sheet processing apparatus is used to perform batch processing of a small quantity of sheets, a plurality of batches of sheets are continuously processed with header cards being inserted between the respective batches. In general, a magnetic stripe, magnetic pattern, or the like for causing a detection unit to recognize a header card is printed on the header card. In addition, a barcode indicating identification information of a sheet to be handled, a serial number, a customer number, and the like are printed on the card. A trailer card which indicates the end of a batch is sometimes used in combination with a header card. On this trailer card, a magnetic stripe or magnetic pattern for differentiating the card from the header card is printed without any barcode or serial number printed on the header card. In addition, the entire surface of some trailer card is colored to improve the visibility to an operator.

In the conventional sheet processing apparatus, however, when a header card is fed or conveyed together with preceding and succeeding sheets, a card detection unit cannot always recognize pattern print as a characteristic feature of the header card, barcode indicating the identification information of a sheet, serial number, customer number, or the like. For this reason, the batch processing is executed again, or the operator manually performs operation. In order to reduce such problems, for example, the following methods have been proposed in PCT (WO) 2000-503956: (1) a method of reducing the occurrence of picking up both a card and a sheet together by inserting a trailer card or dummy card indicating the end of a batch so as to be paired with a header card; (2) a method of allowing the detection unit to read identification information recorded on a header card, even if both a card and a sheet are picked up together, by writing various kinds of identification information on the two surfaces of the card and making the detection unit recognize the card from its two surfaces; and (3) a method of allowing recognition that a header card has been picked up, even if the header card and one or more sheets are picked up together, by mounting a magnetic stripe or conductive material on the card.

If, however, a card is picked up together with preceding and succeeding sheets, the card cannot be recognized by methods 1 and 2 described above. According to method 3, although a header card can be recognized, the barcode information, serial number, customer number, and the like which the card has cannot be recognized.

### BRIEF SUMMARY OF THE INVENTION

The present invention has been made in consideration of the above situation, and has as its object to provide a sheet processing technique which can easily detect the identification information of a partition card indicating the segmentation of a batch and the identification information of a sheet which are recorded on the partition card, even if the card is picked up and conveyed together with adjacent sheets.

According to the present invention, there is provided a sheet processing apparatus comprising a loading unit in which one or a plurality of batches of target media are loaded in a stacked state, each batch including sheets stacked for each operation unit and a partition card which is stacked on the sheets and includes a card base material and a radio chip in which at least identification information of the card is recorded, a pickup mechanism which picks up the target medium from the loading unit, a card recognition unit which is provided after the pickup mechanism and detects identification information from the radio chip, a discrimination unit to detect and discriminate a feature of the target medium, a collecting unit which collects the sheets on the basis of a discrimination result obtained by the discrimination unit, and a rejecting unit which collects the partition card on the basis of the discrimination result obtained by the discrimination unit.

According to the present invention, there is provided a partition card which is placed to partition collected sheets for each operation unit when the sheets are loaded into a sheet processing apparatus for detecting, discriminating, and collecting the sheets, comprising a card-like base material and a radio chip in which at least identification information of the card is recorded.

Processing sheets by using the present invention makes it possible to easily detect the identification information of a partition card and the identification information of a sheet even if the partition card is picked up and conveyed together with adjacent sheets.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing the arrangement of an example of a sheet processing apparatus according to the present invention;

FIG. 2 is a front view showing an example of a header card used in the present invention;

FIG. 3 is a front view showing an example of a trailer card used in the present invention;

FIG. 4 is a flowchart for the identification and pickup of a target medium;

FIG. 5 is a flowchart for the identification and pickup of a target medium; and

FIG. 6 is a block diagram showing a mechanism of recognizing a partition card by radio.

### DETAILED DESCRIPTION OF THE INVENTION

An embodiment of the present invention will be described with reference to the views of the accompanying drawing.

Note that the following embodiment is an example of the present invention, and the present invention is not limited to this.

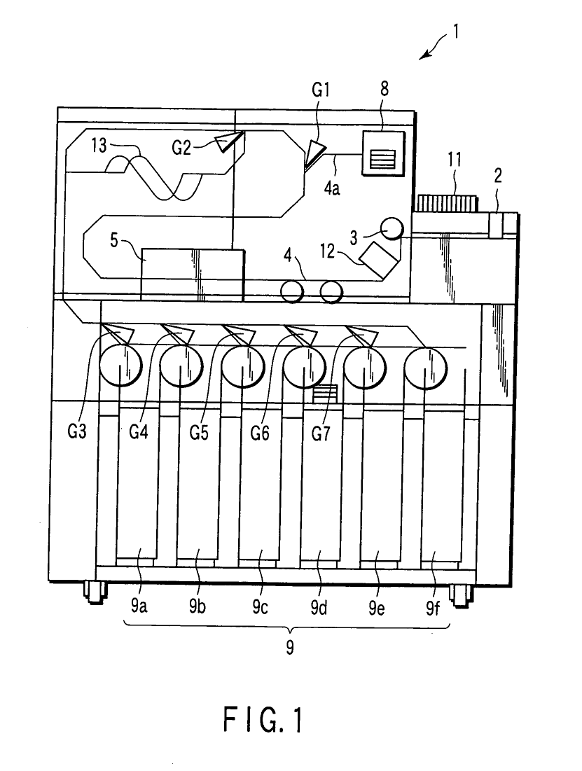

FIG. 1 is a schematic view showing the arrangement of a banknote processing apparatus 1 (to be simply referred to as the processing apparatus 1 hereafter) as an example of a sheet processing apparatus according to the present invention, which checks, for example, banknotes (sheets) sent from a plurality of banks and bind them for reuse.

The processing apparatus 1 includes a loading unit 2 in which a plurality of banknotes in a stacked state with header cards (to be described later) being inserted between them are to be loaded. A radio frequency identification (RFID) chip is mounted on a header card. Items of information such as card identification information, e.g., information which identifies the header card, the identification information of a sheet, e.g., the customer number of each banknote for each processing unit, and the serial number of the card used in this processing unit can be registered in this radio chip.

As processing to be performed before the loading of banknotes into the processing apparatus 1, the above one header card can be stacked on target media corresponding to one processing unit (to be referred to as a batch hereinafter), e.g., one group of banknotes of the same denomination sent from bank branches. In addition, as target media of the next batch, banknotes and a header card can be stacked on the above target media.

In addition, depending on operation, a header card and a trailer card can be respectively placed at the front and rear ends of a batch. A radio chip is also mounted on this trailer card. Card identification information, e.g., information which identifies the trailer card, can be registered in this radio chip.

A case wherein both a header card and a trailer card are used will be described below. Note that the numbers of banknotes of the respective batches are not necessarily the same. In this manner, stacked target media 11 comprising banknotes corresponding to the number of batches that can be loaded at once, header cards each of which partitions the front end of the corresponding batch from others, and trailer cards each of which partitions the rear end of the corresponding batch from others are loaded into the processing apparatus 1.

At this time, the operator inputs, as data associated with the banknotes of each batch, a bank name, a bank branch name, the denomination of banknotes, the number of banknotes, and the like in association with the information registered in the radio chip on a header card inserted for each batch. The batch data input in the preprocessing in this manner are used for collation with the counting result obtained by the processing apparatus 1 in postprocessing.

The rear side of the loading unit 2 is provided with a pickup mechanism 3 which picks up the header card, banknotes, and trailer card (which may sometimes be generically termed as target media hereinafter), which are loaded into the loading unit 2, one by one from the foremost end of the batch. The pickup mechanism 3 is designed to, for example, hold vertically or horizontally and pick up target media at a predetermined pitch upon reception of driving force from a motor and feed then onto a conveying path 4.

The convey path 4 which conveys the target medium, picked up by an attraction roller and the like, through inside the processing apparatus 1 extends on the downstream side of the pickup mechanism 3. A conveyor belt (not shown) and driving pulleys are arranged on the conveying path 4. A target medium is conveyed at a predetermined speed through the conveying path 4 by causing the conveyor belt to travel using a driving motor (not shown).

An RFID reader 12 is provided as a card recognition unit which detects identification information from a radio chip on the conveying path 4 extending from the pickup mechanism 3. The RFID reader 12 receives information communicated from a radio chip in a noncontact manner when a header card passes, and sends the received information data to a control unit (not shown). In addition, a conveyed target medium is always monitored by the control unit.

A discrimination unit 5 for detecting a feature of a target medium conveyed through the conveying path 4 and discriminating the medium is provided after the RFID reader 12. The discrimination unit 5 can be provided with, for example, a detection unit (not shown) which detects a feature of a target medium, a detection information processing unit (not shown) which processes the detection information of the target medium which is sent from the detection unit, and the like. The detection unit can detect the thickness of a target medium recognized as a header card by using, for example, information data from the RFID reader 12. If it is determined that the thickness of the target medium corresponds to two or more banknotes, it is highly possible that a header card is conveyed together with a banknote. In addition, if a thickness corresponding to three or more media is detected, it is deduced that a header card is conveyed while being sandwiched between preceding and succeeding banknotes. Assume that identification information such as a customer number or serial number recorded on a header card is a barcode. In this case, if a header card is conveyed while being sandwiched between banknotes, no number information can be obtained, and the corresponding batch cannot be properly processed. It is therefore necessary to stop the operation of the machine or manually perform collation afterward. In contrast to this, in the processing apparatus according to the present invention, there is no need to print any barcode on a header card. In addition, even if media are conveyed in a stacked state, since card information and the information of a target medium can be detected from a radio chip in a noncontact manner, stable batch processing can be realized.

Note that even if a trailer card is additionally used, stable batch processing can be realized. According to the present invention, however, since the existence of a card is recognized even if the card and other media are conveyed in a stacked manner, stable batch processing can be performed without using any trailer card.

Six gates G1 to G7 are sequentially arranged on the convey path 4 on the downstream side of the discrimination unit 5. The gates G1 to G7 are switched to direct the target medium to a predetermined processing unit under the control of a control unit (not shown) on the basis of the detection result obtained by the discrimination unit 5.

The gate G1 placed immediately behind the discrimination unit 5 is provided at a position to make the convey path 4 branch off to a rejection conveying path 4a. The gate G1 is switched to cause a rejected note detected not as an authentic banknote through the discrimination unit 5 or a header card to branch off to the rejection conveying path 4a. A rejection collecting unit 8 (rejecting unit) is provided at the end of the rejection conveying path 4a. Rejected notes and header cards are stacked in the rejection collecting unit 8 in the order in which they are picked up without being changed in their postures as they were picked up by the pickup mechanism 3, i.e., without having their obverse and reverse surfaces reversed. For example, a header card which is loaded into the loading unit 2 with its obverse surface facing up and picked up is stacked in the rejection collecting unit 8 with its obverse surface facing up. In addition to such rejected notes and header cards, banknotes picked up in a stacked state, banknotes and header cards picked up in a stacked state, header cards picked up in a stacked state, trailer cards, and the like are stacked in the rejection collecting unit 8.

The sheet determined as authentic by the discrimination unit 5 further travels on the conveying path 4, and it is discriminated on the basis of direction information from the discrimination unit 5 whether the sheet is to travel to a reversing unit 13 through the next gate G2 or to further travel without passing through the reversing unit 13. The reversing unit 13 is a mechanical unit capable of reversing, for example, the obverse and reverse surfaces of a banknote or its forward and backward orientations. The reversing unit 13 can adjust sheets supplied in four different directions (obverse/forward, obverse/backward, reverse/forward, and reverse/backward) to one direction (e.g., obverse/forward) or two directions (e.g., obverse/forward and obverse/backward). The reversing unit 13 can be omitted as needed.

First to sixth collecting units 9a to 9f (to be generically termed as a collecting unit 9 hereinafter, as needed) for collecting and binding sheets are arranged at positions where the convey path 4 is made to branch off by the gates G3 to G7 provided along the conveying path 4 on the downstream side of the gate G2. The collecting unit 9 collects and binds only authentic notes of the banknotes, other than rejected notes guided through the gate G1, which can be reused. For example, the first and second collecting units 9a and 9b each are used to collect and bind 100 authentic notes with their obverse surfaces facing up. The third and fourth collecting units 9c and 9d each are used to collect and bind 100 authentic notes with their reverse surfaces facing up. The authentic notes bound by the collecting unit 9 are delivered outside the apparatus through a conveyor (not shown) and the like to be reused.

Using the sheet discrimination apparatus according to the present invention makes it possible to accurately recognize a serial number, customer number, and the like as identification information recorded on a card as well as identifying a header card indicating the segmentation of a batch even if the header card is picked up and conveyed together with preceding and succeeding banknotes. Likewise, using this apparatus makes it possible to accurately recognize a trailer card indicating the end of a batch even if it is picked up and conveyed together with a banknote.

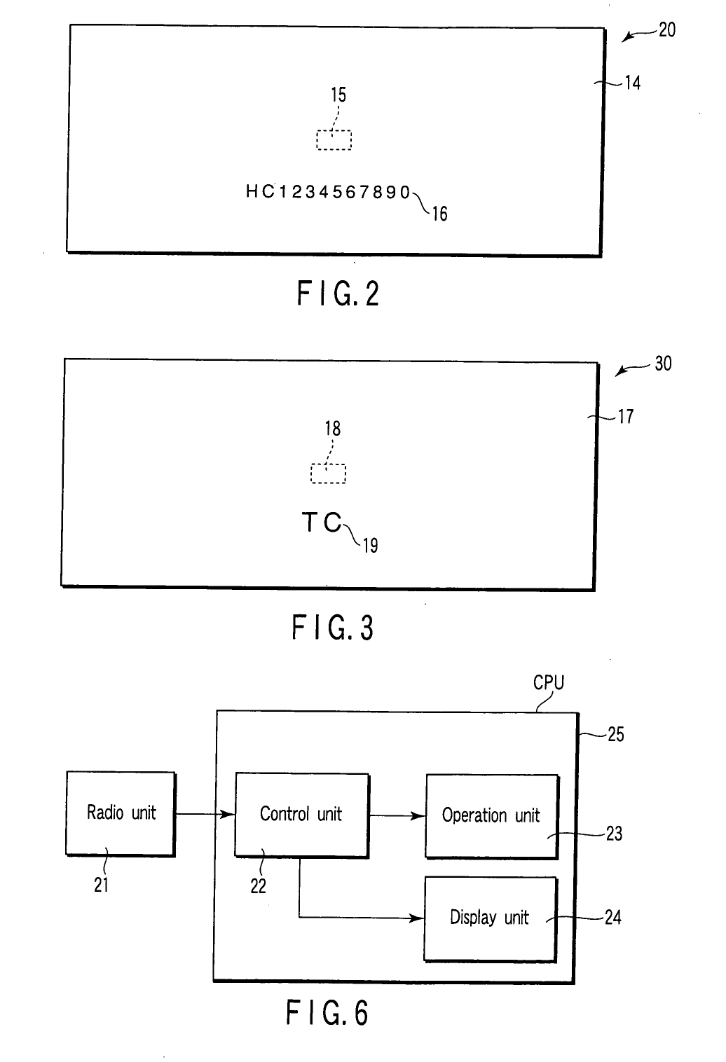

FIGS. 2 and 3 respectively show examples of a header card and trailer card used in the present invention.

In this case, each target medium is rectangular in shape and conveyed in a direction perpendicular to the long side.

As shown in FIG. 2, a header card 20 is designed such that a radio chip 15 having a size of, for example, 1×1 mm on which the identification information of the card and sheets can be recorded is provided in a central portion of a rectangular card base material 14 having a size of, for example, 160×85 cm. In addition, text information 16, e.g., the serial number of the header card, can be printed on at least one major surface to allow the operator to identify the upper or lower surface of the header card and visually determine that the currently processed card is a header card. The thickness of a header card differs from that of a banknote to facilitate identification of the card.

As shown in FIG. 3, a trailer card 30 is designed such that a radio chip 18 having a size of, for example, 1×1 mm on which the identification information of the card and sheets can be recorded is provided in a central portion of a rectangular card base material 17 having a size of, for example, 160×85 cm. In addition, text information 19 of the trailer card 30 can be printed on at least one major surface to allow the operator to identify the upper or lower surface of the header card and visually determine that the currently processed card is a trailer card. The thickness of the trailer card 30 differs from that of a banknote to facilitate identification of the card. In addition, since each trailer card indicates the end of a batch, the identification information to be registered can have the same contents on all trailer cards.

Note that the above header card and trailer card each can be formed by placing a radio chip in the center of a pair of card base materials made of, for example, a plastic or paper material, and stacking the pair of card materials and bonding them by, for example, thermal fusion or using an adhesive. Placing the radio chip in the center makes it possible to place the radio chip in the center either in longitudinal or lateral conveyance.

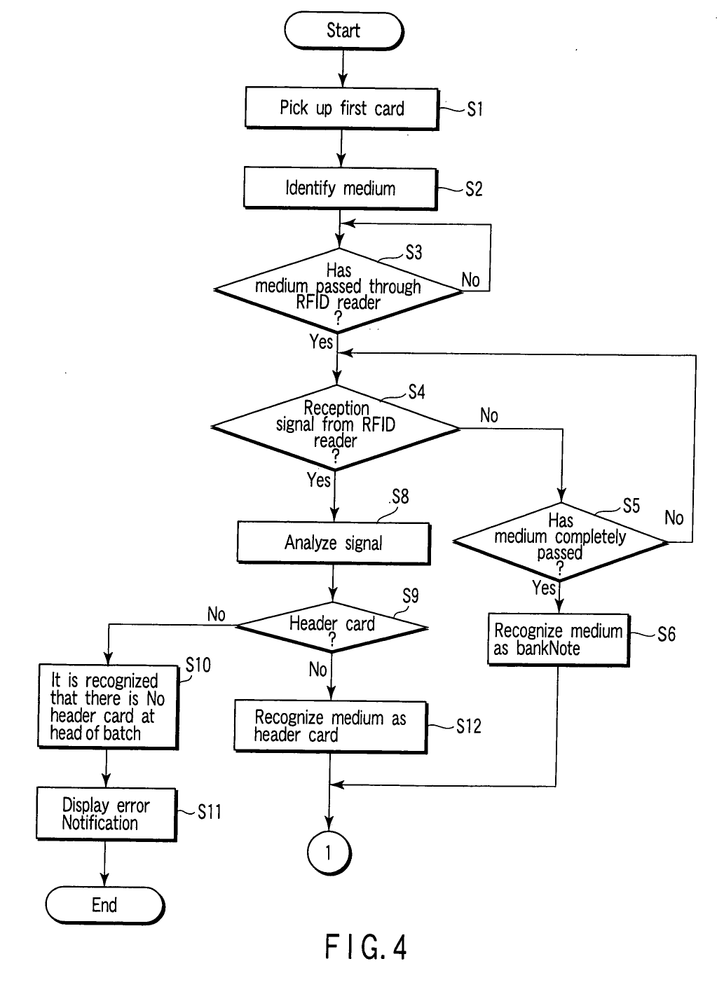

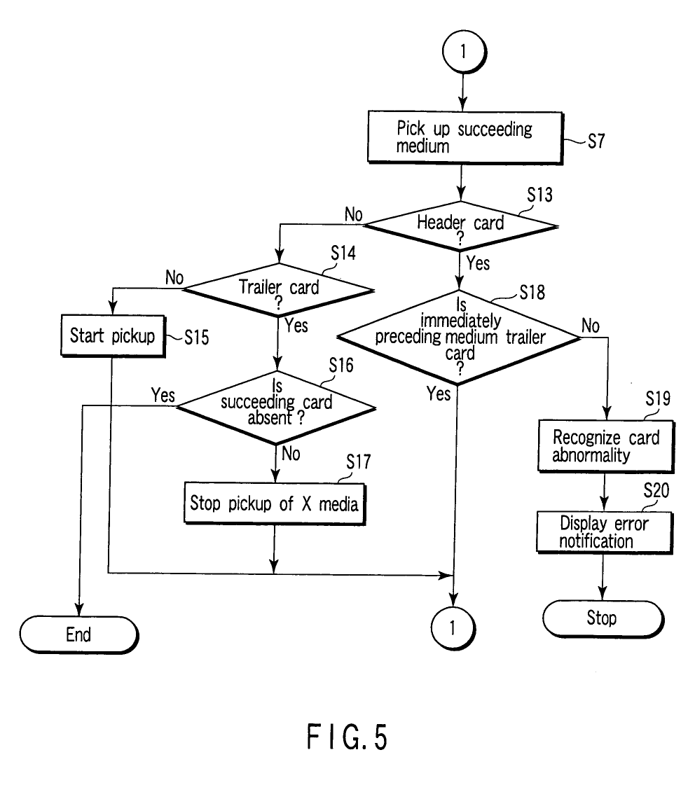

An example of a batch processing system using the header card shown in FIG. 2 and the trailer card shown in FIG. 3 will be described with reference to the flowchart of FIGS. 4 and 5 for the identification and pickup of a target medium and the block diagram of FIG. 6 showing a radio unit.

First of all, a plurality of batches, each comprising a header card, stacked sheets, and a trailer card, are supplied in one lot to the loading unit 2 of the processing apparatus 1.

The operator then issues an instruction to start operation from an operation unit 23 (not shown) to pick up the first target medium (S1).

Upon reception of this instruction, identification of the first target medium is started (S2).

It is then detected whether the target medium has passed through the RFID reader 12 (S3). If the medium has not passed through the reader, detection is continued.

If the medium has passed through the RFID reader 12, it is discriminated whether a control unit 22 has received an identification information signal associated with a card and banknote which the RFID reader 12 has received from the radio chip (S4).

If the control unit 22 has not received the identification information signal, it is discriminated whether the medium has completely passed through the RFID reader 12 (S5).

If the medium has not completely passed through the RFID reader 12, it is discriminated again whether the control unit 22 has received the identification information signal associated with the card and banknote from the RFID reader 12 (S4). If the medium has completely passed through the RFID reader 12, it is recognized that the target medium is a banknote (S6), and identification of a succeeding target medium is performed (S7).

If the control unit 22 has received the identification information signal, the signal is analyzed (S8), and it is discriminated whether the medium is a header card (S9).

If the medium is not a header card, it is recognized that no header card is present at the head of the batch (S10). The control unit 22 then notifies the operation unit 23 and a display unit 24 of this information, and causes the display unit 24 to display information indicating that there is no header card (S11), and terminates the pickup of a target medium.

If the medium is a header card, it is recognized that the medium is a header card (12), and a succeeding medium is picked up (S7), and it is discriminated, as in steps S3, S4, and S8, whether the medium is a header card.

If the medium is not a header card, it is discriminated whether the medium is a trailer card (S14). If the medium is not a trailer card, pickup operation is started (S15). If the medium is a trailer card, it is discriminated whether there is any succeeding card (S16). If there is a succeeding card, the pickup of X media is stopped (S17). If there is no succeeding card, the processing is terminated.

If the medium is a header card, it is discriminated whether the immediately preceding medium is a trailer card (S18). If the immediately preceding medium is not a trailer card, card abnormality is recognized (S19). The control unit 22 notifies the operation unit 23 and the display unit 24 of the error, causes the display unit 24 to display the error (S20), and stops the processing. If the immediately preceding medium is a trailer card, the pickup of succeeding media is started (S7).

In addition, a card equipped with the above RFID can also be made to function as a simulation card aimed at adjusting a device as well as the above header card or trailer card.

Making items of unique code information correspond to banknotes of various countries makes it possible to recognize conveyance/sorting operation of banknotes for the respective denominations, thereby realizing an efficient, low-cost sheet processing apparatus.

As examples of unique code information, Table 1 given below indicates the relationship between items of RFID code information (e.g., 16 bits) and note types.

TABLE 1

Note Code

| Upper | Lower | Denomination |
|---|---|---|
| 01 | 55 | Header card |
| 01 | AA | Trailer card |
| 11 | 1 | ¥1000 |
| 11 | 2 | ¥2000 |
| 11 | 3 | ¥5000 |
| 11 | 4 | ¥10000 |
| 12 | 1 | $1 |
| 12 | 2 | $2 |
| 12 | 3 | $5 |
| 12 | 4 | $10 |
| 12 | 5 | $20 |
| 12 | 6 | $50 |
| 12 | 7 | $100 |
| 13 | 1 | 5 Euro |
| 13 | 2 | 10 Euro |
| 13 | 3 | 20 Euro |
| 13 | 4 | 50 Euro |
| 13 | 5 | 100 Euro |
| 13 | 6 | 200 Euro |
| 13 | 7 | 500 Euro |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sheet processing apparatus comprising:
a loading unit in which one or a plurality of batches of target media are loaded in a stacked state, each batch including sheets stacked for each operation unit and a partition card which is stacked on the sheets and includes a card base material and a radio chip in which at least identification information of the card is recorded;
a pickup mechanism which picks up the target medium from the loading unit;
a card recognition unit which is provided after the pickup mechanism and detects identification information from the radio chip;
a discrimination unit to detect and discriminate a feature of the target medium;
a collecting unit which collects the sheets on the basis of a discrimination result obtained by the discrimination unit; and
a rejecting unit which collects the partition card on the basis of the discrimination result obtained by the discrimination unit.

2. An apparatus according to claim 1, wherein as the partition card, a header card which is stacked on a front end of the collected sheets in a pickup direction and has identification information of the sheet and the partition card recorded in the radio chip is used.

3. An apparatus according to claim 1, wherein as the partition card, a trailer card which is stacked on a rear end of the collected sheets in the pickup direction and has identification information of the partition card recorded in the radio chip is used.

4. A partition card which is placed to partition collected sheets for each operation unit when the sheets are loaded into a sheet processing apparatus for detecting, discriminating, and collecting the sheets, comprising
a card-like base material and a radio chip in which at least identification information of the card is recorded.

5. A card according to claim 4, wherein the card is stacked on a front end of the collected sheets in a pickup direction, and is used as a header card with identification information of a sheet being further recorded in the radio chip.

6. A card according to claim 4, wherein the card is stacked on a rear end of the collected sheets in the pickup direction, and is used as a trailer card.
